(19) United States
(12) Patent Application Publication
(10) Pub. No.: US 2026/0112146 A1
(43) Pub. Date: Apr. 23, 2026

(54) Fine-Grained Action Classification and Regression

(71) Applicant: HONG KONG APPLIED SCIENCE AND TECHNOLOGY RESEARCH INSTITUTE COMPANY LIMITED, Shatin (HK)

(72) Inventors: King Wai Chow, Yuen Long (HK); Chung Wai Wong, Taikoo Shing (HK)

(21) Appl. No.: 18/922,855

(22) Filed: Oct. 22, 2024

(51) Int. Cl. G06V 10/764; G06T 7/73; G06V 10/25

(52) U.S. Cl. CPC G06V 10/764; G06T 7/73; G06V 10/25; G06T 2207/20081; G06V 2201/07

(57) ABSTRACT

Methods and a non-transitory computer-readable storage medium for fine-grained action classification and/or regression are disclosed. The method includes: receiving a video stream capturing a sequence of human subject actions; identifying reference objects with spatial-temporal relationships to the action sequence; extracting a pose dataset representing the action sequence; extracting object datasets representing spatial positions of the reference objects; generating a compound data structure integrating the pose dataset and object datasets; and inputting the compound data structure into a trained machine learning model for classification and/or regression.

### FIELD OF THE INVENTION

The present invention relates to video action recognition. Specifically, the present invention relates to fine-grained action classification and regression.

### BACKGROUND OF THE INVENTION

Machine learning has revolutionized human action classification and assessment in recent years. Traditional approaches relied heavily on hand-crafted features and rule-based systems, which were often limited in their ability to generalize across diverse scenarios. With the advent of deep learning techniques, particularly Convolutional Neural Networks (CNNs) and Recurrent Neural Networks (RNNs), researchers have developed more robust and accurate models. These networks can automatically learn hierarchical features from raw input data, such as video frames or motion capture data, enabling them to classify complex human actions.

Patent application No. US20210275107A1 discloses a computer-implemented method for human gait analysis extracts three-dimensional gait information from a video stream of an individual's walk. The three-dimensional gait information includes estimates of joint locations, including foot locations, on each frame. The method determines gait parameters based on foot locations in local extrema frames, providing a comprehensive understanding of the individual's gait.

Patent application No. US20220079472A1 discloses a fall-detection system detects personal falls while maintaining privacy by receiving a sequence of video images of a monitored person. The system processes each image, identifying the person and extracting a skeletal figure. The system then labels each figure with an action among predetermined actions, generating a fall/non-fall decision for the detected person.

Patent application No. US20240037977A1 discloses an apparatus consists of a joint-determination module, a pose estimation module, and an action-identification module. It analyzes an image containing one or more people using a computational neural network, derives pose estimates from these candidates, and analyzes a region of interest to identify an action.

However, current methods face limitations when more nuanced evaluation is required. In scenarios where the degree of compliance or quality of specific actions needs assessment (such as worker assembly actions or elderly motor skills), a finer level of granularity is necessary.

### SUMMARY OF THE DESCRIPTION

The invention addresses this need by introducing a spatial-temporal video dataset for fine-grained action classification and regression.

One aspect of the embodiment of the present invention discloses a method of implementing fine-grained action classification and/or regression by a system comprising a processor and a non-transitory computer-readable storage medium storing instructions that, when executed, cause the system to perform the method comprising: receiving (S110) at least one video stream capturing a sequence of human subject actions; identifying (S140) at least one reference object with spatial-temporal relationships to the sequence of human subject actions; extracting (S130) a pose dataset representing the sequence of human subject actions; extracting (S160) at least one object dataset representing the spatial positions of the at least one reference object; generating (S170) a compound data structure that integrates the pose dataset and the at least one object dataset; and inputting (S180) the compound data structure as into a trained machine learning model for classification and/or regression.

Another aspect of the embodiment of the present invention discloses a method of implementing quality prediction or compliance prediction by a system comprising a processor and a non-transitory computer-readable storage medium storing instructions that, when executed, cause the system to perform the method, comprising: receiving (S710) N compound data structures each generated according to the method of claim 1, wherein compound data structures 1 to N are each associated with a sequence of human actions which should comply with a set of specified procedural standards, and each of the sequences of human actions 1 to N is associated with an assembly portion of a final product; adding (S720) a timestamp from a global clock for each compound data structure, wherein each of the compound data structures includes timestamp information for each extracted frame; concatenating (S730) the N compound data structures according to their timestamp information to form a temporal sequence of data structures.

Another aspect of the present invention provides a non-transitory computer-readable storage medium storing instructions that, when executed by one or more processors, cause a processing system to perform the method for fine-grained action classification and/or regression as disclosed herein. This computer-readable medium embodies the method in a form that can be directly utilized by computing devices to implement the invention's functionalities.

### BRIEF DESCRIPTION OF THE DRAWINGS

The present invention is illustrated by way of example and not limitation in the FIGS. of the accompanying drawings in which like references indicate similar elements.

FIG. 1 is a flow chart illustrating an exemplary method of an inference phase for fine-grained action classification and regression, according to an embodiment of the disclosure.

FIGS. 2A and 2B are an exemplary schematic diagram depicting the generation of a compound data structure for fine-grained action classification and regression, according to an embodiment of the disclosure.

FIG. 3 is a flow chart illustrating an exemplary method of a training phase for fine-grained action classification and regression, according to an embodiment of the disclosure.

FIG. 4 is a schematic diagram depicting an example scene for gait assessment, according to an embodiment of the disclosure.

FIG. 5 is a flow chart illustrating an exemplary method of a training phase for gait assessment, according to an embodiment of the disclosure.

FIG. 6 is a schematic diagram depicting an exemplary assembly line for production of ink cartridges, according to an embodiment of the disclosure.

FIG. 7 is a flow chart illustrating an exemplary method of an inference phase for quality prediction of a final product, according to another embodiment of the disclosure.

FIG. 8 is a flow chart illustrating an exemplary method of an inference phase for compliance prediction of a final product, according to another embodiment of the disclosure.

FIG. 9 is a flow chart illustrating an exemplary method of a training phase for compliance prediction of a final product, according to another embodiment of the disclosure.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

The first embodiment of this disclosure pertains to fine-grained action classification or assessment in the context of the assembly of printer ink cartridges on a factory production line.

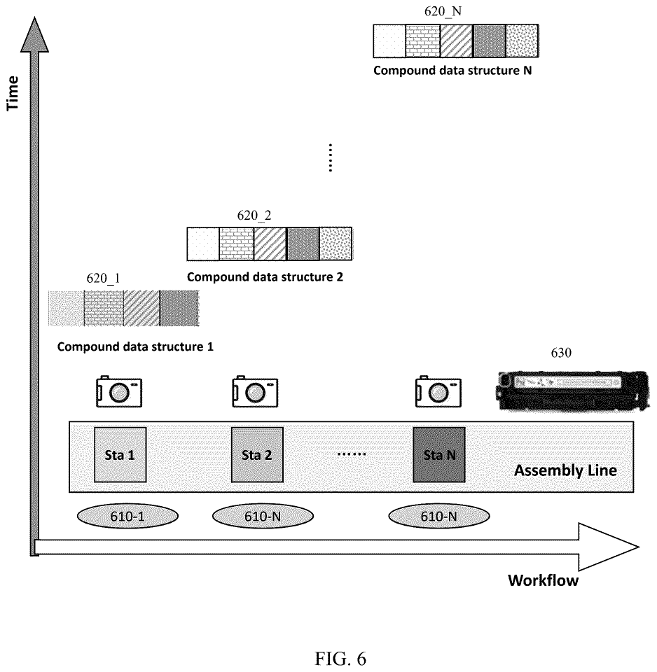

FIG. 6 is a schematic diagram depicting an exemplary assembly line for production of ink cartridges 630, according to an embodiment of the disclosure. The assembly line comprises Assembly Stations 610-1 through 610-N, where each assembly station is responsible for completing a portion of the printer cartridge assembly work in accordance with a predetermined workflow sequence. Workers at each assembly station are required to follow their respective standard operating procedures to complete the work at that particular station.

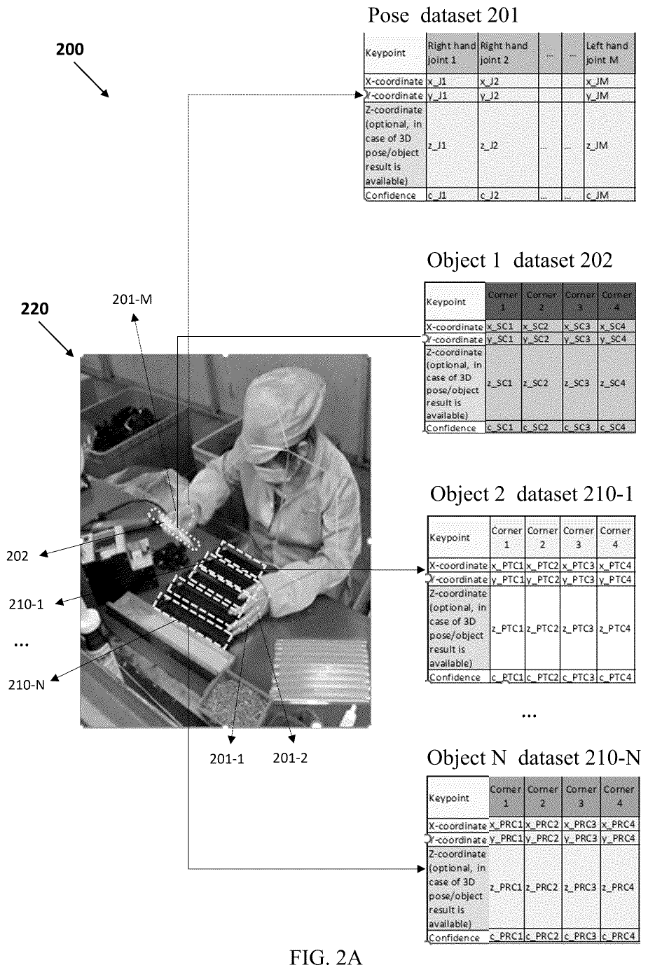

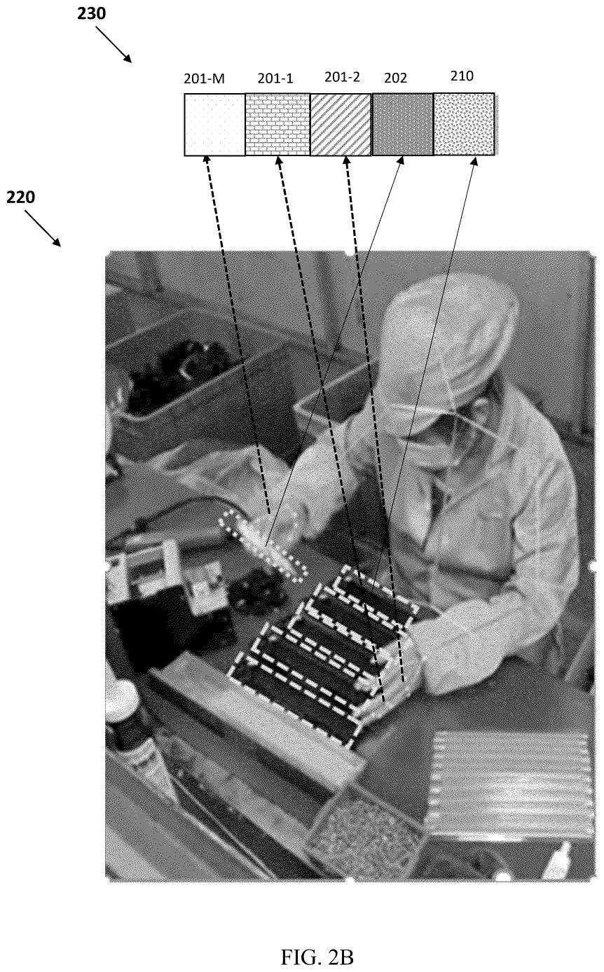

FIGS. 2A and 2B is an exemplary schematic diagram depicting the generation of a compound data structure for fine-grained action classification and regression, according to an embodiment of the disclosure.

Picture 220 in FIGS. 2A and 2B illustrates one of Assembly Stations along the production line, which can be Assembly Station 610-1 shown in FIG. 6.

According to the standard operating procedure (SOP) for Assembly Station 610-1, workers are required to perform a series of intricate actions. One such critical task involves the worker using a handheld nozzle 202 to apply adhesive precisely to designated areas on each ink cartridge component 210-1 to 210-N.

In conventional processes, ensuring adherence to the SOP across all assembly stations typically relies on downstream quality assurance (QA) procedures. These QA checks involve inspecting the fully assembled ink cartridges at the end of the production line. For instance, QA personnel manually examine whether all cartridge components 210-1 to 210-N have been properly glued.

This traditional approach, however, presents significant challenges. It requires QA staff to possess an in-depth understanding of how improperly glued components appear, which can be subtle and difficult to detect. This level of expertise is crucial for effectively identifying assembly errors, such as missed adhesive applications.

The reliance on post-assembly QA checks not only demands highly skilled personnel but also introduces potential inefficiencies.

To address the limitations of traditional quality control methods in assembly line operations, there is a need for analysis of worker actions through video footage. This approach aims to evaluate whether assembly procedures at each station adhere to the standard operating procedure, as any deviation could result in defective components in the final product.

Existing technology, such as Vision Transformers, has been used for human action classification and assessment. This approach divides images into small pixel patches, which are then processed through a tokenization phase. After training on labeled video data, the model excels in two key areas: predicting action classes (like drinking water or brushing teeth) and assessing action quality (such as evaluating the correct form in physical exercises). However, the approach lacks the granularity needed to accurately classify or score actions based on specific procedural standards.

According to the embodiment disclosed in this disclosure, a novel approach is proposed for fine-grained action classification and regression. This method leverages the spatial-temporal relationships of specific keypoints derived from human pose estimation, along with their interactions with selected reference objects in the surrounding environment.

Specifically, according to the embodiments of this disclosure, the processes described herein with reference to the flowcharts can be implemented as computer programs. For example, the embodiments of this disclosure provide a computer program product that includes a computer program carried on a computer-readable medium, where the computer program contains program code for executing at least one step in the method embodiments of this disclosure.

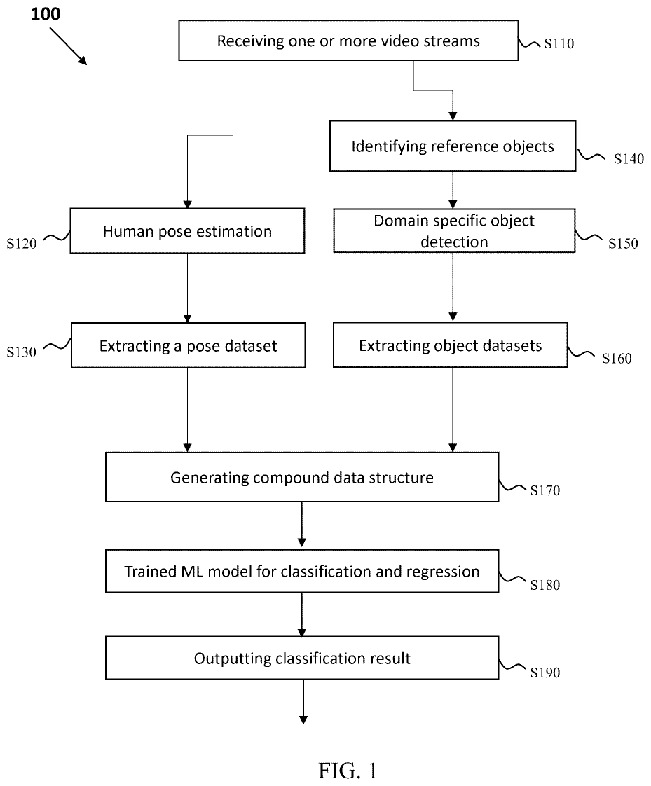

FIG. 1 is a flow chart 100 illustrating an exemplary method of an inference phase for fine-grained action classification and regression, according to an embodiment of the disclosure.

In the embodiment of the disclosure, a method of implementing quality prediction is provided. This method is executed by a system comprising a processor and a non-transitory computer-readable storage medium storing instructions that, when executed, cause the system to perform the method.

At Step S110, the system receives at least one video stream capturing a sequence of human subject actions. In this embodiment, the video streams are captured from one or more cameras located around Assembly Station 610-1 at predetermined intervals. This ensures comprehensive coverage of the area where the actions of human subject are taking place. The camera could be of type RGB, Infrared, or depth or any combination of the aforementioned three sensing modalities.

At Step S120: human pose estimation is applied to a plurality of frames of the received video stream(s) to generate a human pose data stream. The human pose estimation task aims to first form a skeleton-based representation and then process it according to the needs of the final application. 2D and 3D pose estimation techniques are widely employed in the field of human pose analysis. 2D pose estimation involves detecting and localizing key body joints in image or video frames, typically representing them as a set of 2D coordinates (x, y) in the image plane. This approach is computationally efficient and works well for many applications, but lacks depth information. 3D pose estimation, on the other hand, aims to recover the full 3D configuration of the human body, representing joint positions in a 3D coordinate system (x, y, z). The 2D/3D coordinates of key body joints from multiple frames in a video sequence form a human pose data stream.

In one embodiment of the disclosure, as shown in FIG. 2B, the key body joints of a worker are identified in picture 220. These joints include, but are not limited to, the Right hand joint 201-1, Right hand joint 201-2, and Left hand joint 201-M. The human pose estimation process is applied to each frame of the received video stream(s), resulting in a human pose data stream that contains the 2D or 3D coordinates of these key body joints for each processed frame.

For example, consider a worker assembling a batch of 5 cartridge prototypes at Assembly station 601. The complete assembly cycle for this batch takes approximately 90 seconds. If the video of this process is captured at a standard rate of 30 frames per second, it would result in a total of 2700 image frames for the entire cycle (90 seconds*30 frames/second=2700 frames). Consequently, the human pose stream generated from this video would comprise 2700 human pose sets. Each of these sets contains the 2D or 3D coordinates for each of the identified key body joints, extracted from its corresponding frame.

At Step S130: Extracting pose dataset from the human pose data stream. This pose dataset comprises a metadata segment and a plurality of data segments. The metadata segment may include, but is not limited to, the names of keypoints and the names of coordinate systems used. The data segments contain the actual 2D/3D coordinates of keypoints, with the structure and meaning of these coordinates defined by the metadata segment.

Pose dataset 201 shown in FIG. 2 listed pose dataset of a frame from the human pose data stream. The metadata segment from the pose dataset includes the names of keypoints: Right hand joint 1, Right hand joint 2. Left hand joint M, which correspond to the keypoints of the worker shown in the picture 220. The coordinate systems include: X-coordinate, Y-coordinate, and Z-coordinate, and confidence level. The confidence level for each keypoint of the human body, e.g., between 0.0 and 1.0, where 0.0 means no confidence or the key point is typically suppressed whereas 1.0 means almost certain that the key point is present. In pose dataset 201, the actual 2D/3D coordinates of each key body joints are listed with the structure and meaning of these coordinates defined by the metadata segment.

At Step S140: Identifying at least one reference object with spatial-temporal relationships to the sequence of human subject actions. These reference objects provide context for the human actions and are crucial for accurate action classification and regression. In this embodiment, handheld nozzle 202 and ink cartridge component 210-1 to 210-N shown in picture 220 are identified as reference objects with bounding boxes respectively.

At Step S150: Applying domain-specific object detection and segmentation algorithm to the plurality of frames to generate at least one object dataset stream. Faster R-CNN, YOLO (You Only Look Once), SSD (Single Shot Detector) are commonly used for object detection, and U-Net, Mask R-CNN, DeepLab are commonly used for segmentation.

Like the pose dataset, each object dataset comprises a metadata segment and a plurality of data segments. The metadata segment from the object dataset includes the names of keypoints of the object. As shown in picture 220 of FIGS. 2A and 2B, for example, the keypoints of handheld nozzle 202, and ink cartridge components 210-1 to 210-N are Corner 1, Corner 2, Corner 3, Corner 4 of each of their bounding boxes.

At Step S160: Extracting object dataset for each of reference objects. Object datasets 202, 210-1 to 210-N shown in FIG. 2A are object datasets from the same frame as pose dataset 201. In the example described above regarding the worker assembling a batch of 5 cartridge prototypes at Assembly station 601 for a 90-second video stream, the object datasets comprise 2700 sets for the reference objects.

At Step S170: Generating a compound data structure that integrates the pose dataset and the at least one object dataset. For each frame of the video stream, the compound data comprise 2D/3D coordinates of the selected human body's keypoints and 2D/3D coordinates of the keypoints for each of the identified one or more reference object, aligned according to coordinate system. Picture 230 in FIG. 2B schematically illustrates the compound dataset for one frame of the video stream. Datasets 201-M, 201-1, and 201-2 contain the 2D or 3D coordinates of the Left hand joint 201-M, Right hand joint 201-1, and Right hand joint 201-2, respectively. Datasets 202 and 210 contain 2D or 3D coordinates of the corners of the bounding boxes of the handheld nozzle 202, and ink cartridge components 210-1 to 210-N.

In the example described above regarding the worker assembling a batch of 5 cartridge prototypes at Assembly station 601 for a 90-second video stream, the compound data structure includes 2700 sets of human pose data and 2700 sets of object data. Alternatively, one could form a compound set constructed/mapped from the human and target object(s) for each image frame, resulting in a temporal sequence of 2700 compound sets

In one embodiment, a trainable mapping is applied to the compound data structure to generate a fused data structure. The weights of this mapping are learned during a training phase. Notably, the length of the fused data structure is smaller than the sum of the lengths of the pose dataset and the object datasets, allowing for more efficient processing.

At Step S180: The compound data structure (or the fused data structure) is input into a trained machine learning model for fine-grained action classification and regression.

At Step S190: The trained machine learning model outputs a classification result indicating whether the captured series of human actions comply with a set of specified procedural standards.

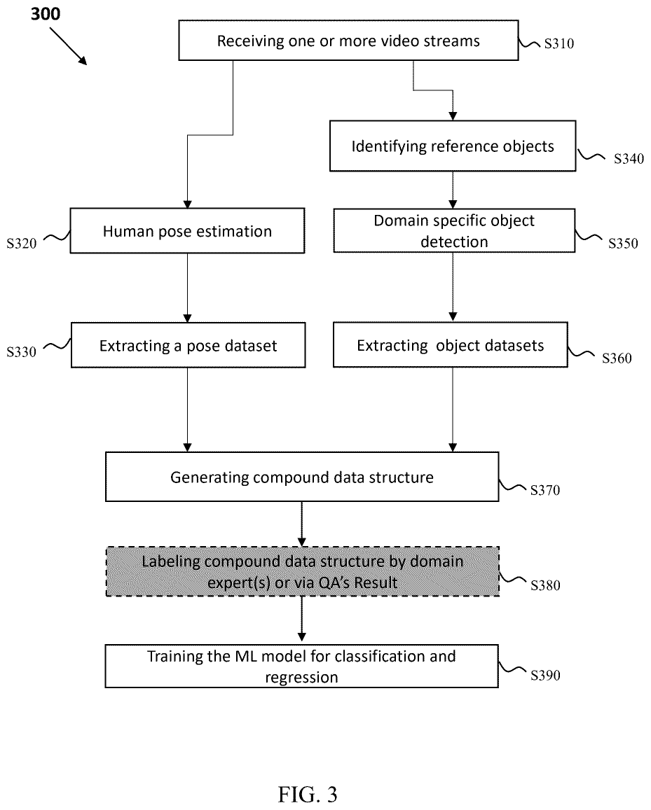

FIG. 3 is a flow chart 300 illustrating an exemplary method of a training phase for fine-grained action classification and regression, according to an embodiment of the disclosure.

During the training phase of the ML model, domain expert(s) are required to perform Quality Assurance (QA) on product components that have passed through the Assembly station 610-1. If the QA process determines that there are issues with the products, they will label the corresponding products accordingly. The training set for the ML model is then created using the compound data structures (or fused data structures) associated with the labeled products, as identified through the Quality Assurance results. At Step S380, this labeled compound data structure by domain expert(s) or via QA's Result is used to train the ML model, resulting in a trained ML model capable of classifying whether a product component is good or not good.

Steps S310 to S370 in the ML model training phase method 300 of FIG. 3 are implemented similarly to steps S110 to S170 in the inference phase of method 100 in FIG. 1. For specific implementation details, please refer to the previous description of method 100 in FIG. 1.

Optionally, the first embodiment of this disclosure described above can be implemented in the context of the tokenization of the AI Transformer or similar framework. Specifically, the compound data structure or fused data structure can be in form of token for a transformer-based machine learning frame work.

According to a second embodiment of this disclosure, the fine-grained action classification and regression method of this disclosure can be used for gait assessment. For example, Tinetti-POMA, which stands for Tinetti Performance Oriented Mobility Assessment, is a widely used tool to assess balance and gait in older adults. It's designed to evaluate a person's risk of falling by observing their performance in various mobility tasks. The test includes various activities such as:
Balance tests: sitting balance, rising from a chair, standing balance (with eyes open and closed), and turning 360 degrees;
Gait tests: initiation of gait, step length and height, step symmetry, step continuity, path deviation, trunk stability, and walking stance.

There are multiple items to be tested throughout the Tinetti-POMA, each with its own scoring criteria. Each scoring item can have a score of 0 or 1. If the total score is too low, the individual would be assessed as having a relatively high risk of falling in this test. For example, in a walking test for the gait assessment, there are the following four scoring items labeled A, B, C, and D.

| | | |
|---|---|---|
| A | Step length | right heel swings past left big toe = 1 |
| | | left heel swings past right big toe = 1 |
| B | Foot clearance | right foot completely clears floor = 1 |
| | | left foot complete clears floor = 1 |
| C | Step symmetry | right and left step length equal = 1 |
| D | Step continuity | steps appear continuous = 1 |

The inference phase and training phase of the method of fine-grained action classification and regression illustrated in FIGS. 1 and 3 can apply to gait assessment. Each test is considered an Assembly station in the first embodiment described above.

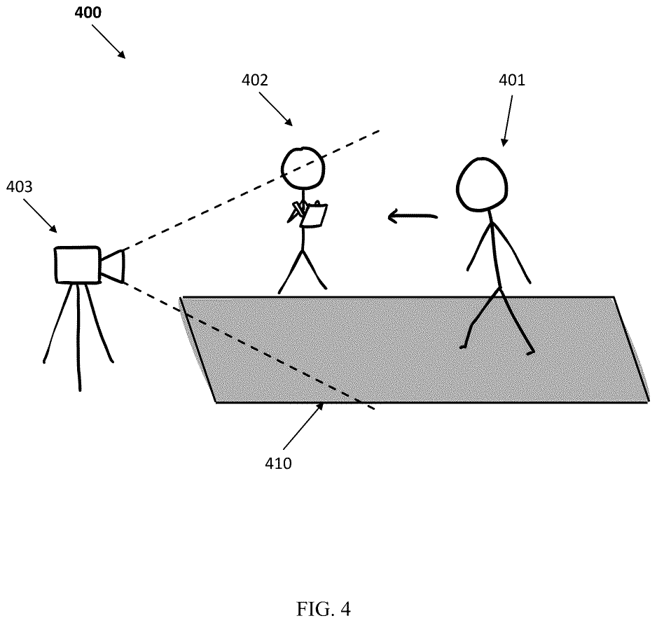

FIG. 4 is a schematic diagram 400 depicting an example scene for gait assessment, according to an embodiment of the disclosure.

FIG. 4 illustrates an example of gait assessment by analyzing a video sequence of a human subject 401 for the walking test, according to an embodiment. In this example, the camera 403 is set up in front of the human subject's 401 path, recording a video sequence of the human subject walking towards the camera 403 and then turning to walk away from the camera 403

During the training phase, a domain expert (physiotherapist/medical doctor) 402 produces a score after observing the “performance” of the human subject.

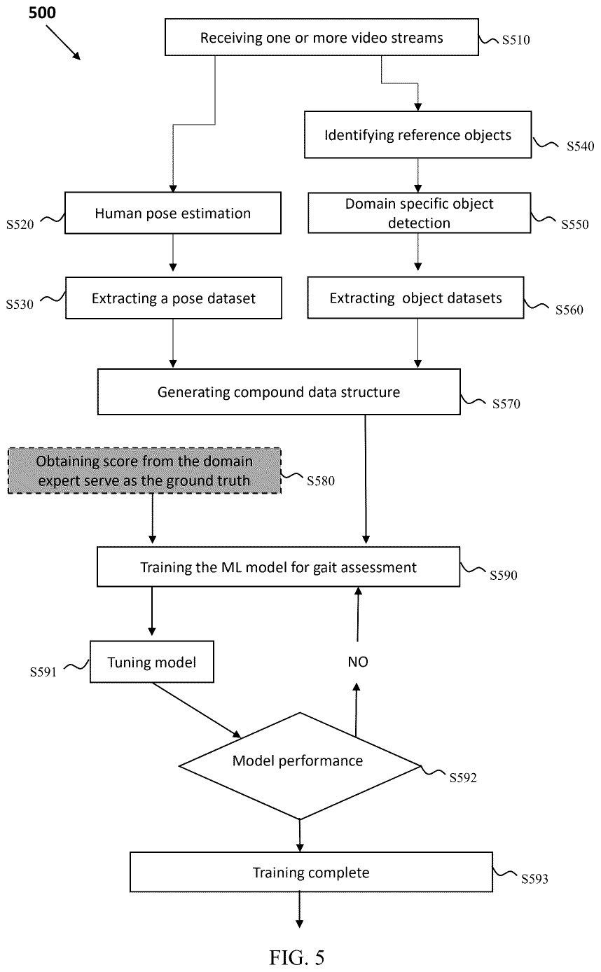

FIG. 5 is a flow chart 500 illustrating an exemplary method of a training phase for gait assessment, according to an embodiment of the disclosure

At Step S510, after receiving video sequences of the entire walking test from camera 403, human pose estimation is applied to multiple frames of the received video stream(s) at Step S520 to generate a human pose data stream. 2D and 3D pose estimation are used to obtain 2D/3D coordinates of key body joints from multiple frames in a video sequence, forming a human pose data stream. In gait assessments, joint points of the human subject, such as the patient's hands or feet, are key points that require special attention.

Next, at Step S530, the pose dataset is extracted from the human pose data stream. This includes a metadata segment containing the names of keypoints and coordinate systems used, and a data segment containing the actual 2D/3D coordinates of key body joints. The structure and meaning of these coordinates are defined by the metadata segment.

At Step S540, at least one reference object with spatial-temporal relationships to the sequence of human subject actions is identified. In this implementation, the reference object can be the ground plane of the floor with bounding box 410 in FIG. 4, or the bounding boxes of the armrests of the chair (not shown).

Then at Step S550, domain-specific object detection and segmentation algorithms are applied to multiple frames to generate at least one object dataset. For example, the generated object dataset may include a metadata segment naming the four corners (Corner 1, Corner 2, Corner 3, Corner 4) of the bounding box indicating the reference object in each frame, and a data segment indicating the 2D/3D coordinates of these four corners respectively.

At Step S560, the object dataset for the reference object is extracted.

At Step S570, a compound data structure is generated that integrates the pose dataset and the object dataset. For each frame of the video stream, the compound data comprise 2D/3D coordinates of the selected human body's keypoints and 2D/3D coordinates of the keypoints for the reference object, aligned according to the coordinate system.

At Step S580, scores obtained from the domain expert serve as the ground truth. Then at Step S590, the scores obtained at Step S580 and the compound data structure obtained at Step S570 are used as the training set to begin the training process of the machine learning model.

Optionally, during the training phase, Step S591 can be used to fine-tune the model: optimizing and adjusting the model based on preliminary training results. Then at Step S592, it's determined whether the model has reached the expected performance level. If the model's performance is unsatisfactory, it returns to the training step for further training and tuning. If the model's performance is satisfactory, the training process is completed.

Optionally, the Second embodiment of this disclosure described above can be implemented in the context of the tokenization of the AI Transformer or similar framework. Specifically, the compound data structure or fused data structure can be in form of token for a transformer-based machine learning frame work.

The third embodiment of this disclosure pertains to quality prediction and compliance prediction for the final product in the context of the assembly of printer ink cartridges on a factory production line, as illustrated in FIG. 6.

The quality of the final product, the printer ink cartridge, depends on whether the workers at each assembly station adhere to the corresponding standard operating procedures when working on specific parts of the printer cartridge. The final printer cartridge product, assembled through the process from Assembly Station 610-1 to Assembly Station N, will subsequently undergo a quality assurance (QA) process to inspect the assembled printer cartridges on the production line. Each cartridge after QA is classified as “Good” or “No Good”, which can be served as a label for training the ML model for quality prediction.

In the event of a “No Good” quality assurance (QA) result, a Production or Industrial Engineer conducts a post-assembly analysis. This analysis serves two primary purposes. First, the engineer endeavors to identify the underlying cause of the product failure. Second, they trace the assembly process backwards to determine at which specific assembly station or stations the error occurred. It's important to note the possibility that multiple assembly stations may have contributed to the product failure. The assembly station error measure could be in the form of probability from 0.0 to 1.0. The aforementioned analysis outcome can be served as the label for training the ML model for compliance prediction.

As illustrated in FIG. 1 and described in the related paragraphs, the videos of worker actions captured at each Assembly Station in the production of ink cartridges can generate a corresponding compound data structure that integrates the pose dataset and at least one object dataset.

According to an embodiment of this disclosure, all the compound data structures related to the production of a final product, obtained from each assembly station on the production line, can be concatenated to generate a temporal sequence of data structure. The temporal sequence of data structure is unique for the final product and can be used to predict the quality of the final product or predict which portion(s) of the assembly process was non-compliant when the quality of the final product is not satisfied.

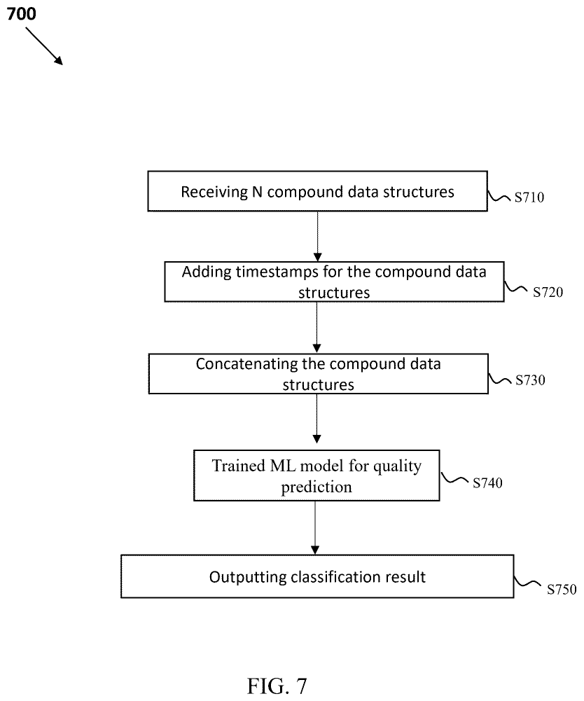

FIG. 7 is a flow chart 700 illustrating an exemplary method of an inference phase for quality prediction of a final product, according to another embodiment of the disclosure.

As shown in FIG. 6, after the final printer cartridge 630 is assembled through the process from Assembly Station 610-1 to Assembly Station 610-N, all the video streams capturing a worker's actions at each Assembly Station are processed as described in relation to steps from S110 to S170 of FIG. 1 to generate compound data structure 1 to compound data structure N. It can be understood that compound data structures 1 to N are each associated with workers' actions at each Assembly Station 610-1 to Assembly Station 610-N respectively, as shown in FIG. 6.

In one embodiment of the disclosure, if conventional QA is NOT performed, a method of implementing quality prediction is provided. This method is executed by a system comprising a processor and a non-transitory computer-readable storage medium storing instructions that, when executed, cause the system to perform the method.

At Step S710, the system for implementing quality prediction or compliance prediction receives the compound data structure 1 to compound data structure N. It's important to note that compound data structures 1 to N are each associated with the worker's actions when working on specific parts of the printer cartridge at each of Assembly Station 610-1 to Assembly Station 610-N respectively.

Following the reception of the compound data structures, at Step S720, the system adds a timestamp from a global clock for each compound data structure. It should be noted that each of the compound data structures already includes timestamp information for each extracted frame. This additional timestamp from the global clock provides a unified time reference across all compound data structures.

At Step S730, the system concatenates the N compound data structures according to their timestamp information. This concatenation results in the formation of a temporal sequence of data structures. This temporal sequence provides a chronological representation of the assembly process for the final product.

At Step S740, the system provides the temporal sequence of data structures as input to a trained machine learning model for quality prediction. The model has been previously trained with labeled QA classification results or final product of cartridge.

Subsequently, at Step S750, the trained machine learning model for quality prediction outputs a classification result “Good” or “No Good” for the final product. This classification result predicts the quality of the final product based on the analysis of the temporal sequence of data structures. The model can serve as pre-screen tool to predict product quality

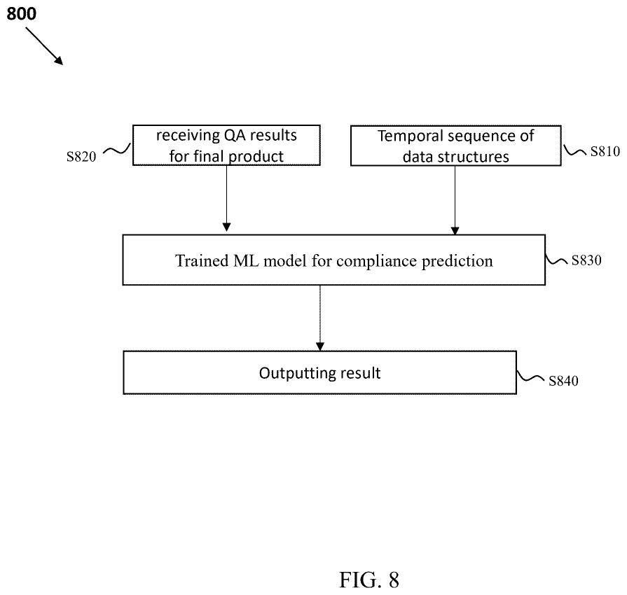

FIG. 8 is a flow chart 800 illustrating an exemplary method of an inference phase for compliance prediction of a final product, according to another embodiment of the disclosure.

In this embodiment of the disclosure, if conventional QA is NOT performed, a method of implementing compliance prediction is provided.

The initial steps of this embodiment (S710, S720, S730) are identical to those described in the previous embodiment. These steps involve receiving N compound data structures, adding global timestamps, and concatenating the structures to form a temporal sequence.

Following the formation of the temporal sequence of data structures, at Step S820, the system receives a result of Quality Assurance (QA) for the final product, i.e., “Good” or “No Good” for the final product.

If the result of the conventional QA indicates that the quality of the final product is unsatisfactory (i.e., a failure), the system proceeds with the following steps.

At Step S830, the system provides two key inputs to a trained machine learning model for compliance prediction: a) The result of QA for the quality of the final product, and b) The temporal sequence of data structures (generated at Step S730).

At Step S840, the trained machine learning model for compliance prediction processes the inputs and outputs an identification of which assembly portion(s) of the final product deviated from the specified procedural standards.

The machine learning model for compliance prediction can predict where non-compliant steps/take place and the relevant corrective action can be administered.

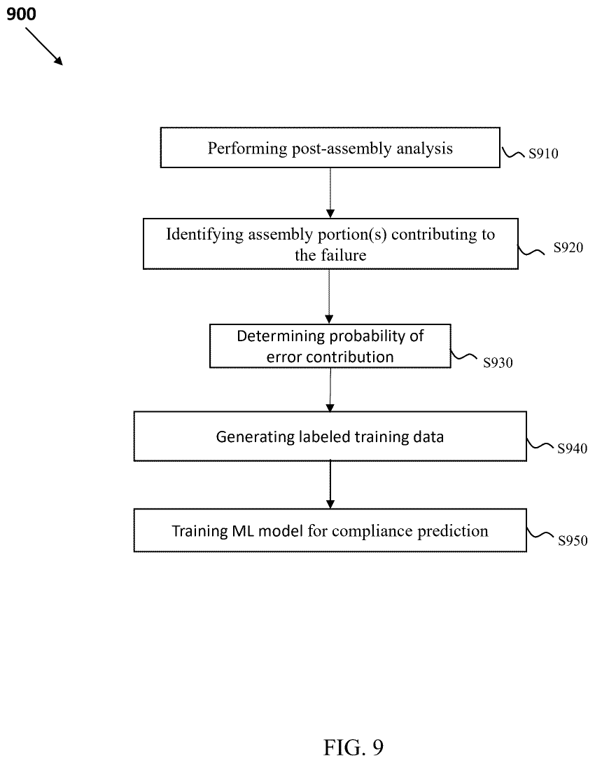

FIG. 9 illustrates a flow chart 900 for a training phase of compliance prediction for a final product, according to the other embodiment of the present disclosure.

The training process begins with a human-driven step.

At Step S910, an engineer performs a post-assembly analysis when a quality assurance (QA) result for a final product indicates a failure. This analysis involves a thorough examination of the failed product and its assembly process to identify potential causes of the failure.

Following the post-assembly analysis, at Step S920, the engineer identifies one or more assembly portions potentially contributing to the failure. For each identified assembly portion, at Step S930, the engineer determines a probability of error contribution. This probability represents the likelihood that the particular assembly portion contributed to the product failure. The probability of error contribution is represented as a value ranging from 0.0 to 1.0. For example, a value of 0.0 would indicate that the assembly portion definitely did not contribute to the failure, and a value of 1.0 would indicate that the assembly portion was certainly responsible for the failure.

Finally, at Step S950, the machine learning model for compliance prediction is trained using the generated set of labeled training data. The model learns to predict potential assembly errors and their probabilities based on the input data.

Optionally, the Third embodiment of this disclosure described above can be implemented in the context of the tokenization of the AI Transformer or similar framework. Specifically, the temporal sequence of data structures can be in form of token for a transformer-based machine learning frame work.

It should be clear to those skilled in the art that, for the sake of convenience and brevity, the specific working processes of the systems, apparatus, devices, and modules described above can be referred to in the corresponding processes in the aforementioned method embodiments, and will not be repeated here.

By studying the drawings, disclosure content, and the attached claims, those skilled in the art, when practicing the subject matter to be protected, can understand and implement variations of the disclosed embodiments. In the claims, the phrase “A and/or B” refers to A, B, or A and B; the word “includes” does not exclude other elements or steps, and the indefinite article “a” or “an” does not exclude multiples. The words “first,” “second,” “third,” “fourth” are merely used to distinguish elements or steps and do not indicate the order of elements or steps. The mere fact that certain measures are recited in mutually different dependent claims does not indicate that a combination of these measures cannot be used to advantage.

1. A method of implementing fine-grained action classification and/or regression by a system comprising a processor and a non-transitory computer-readable storage medium storing instructions that, when executed, cause the system to perform the method comprising:
receiving (S110) at least one video stream capturing a sequence of human subject actions;
identifying (S140) at least one reference object with spatial-temporal relationships to the sequence of human subject actions;
extracting (S130) a pose dataset representing the sequence of human subject actions;
extracting (S160) at least one object dataset representing the spatial positions of the at least one reference object;
generating (S170) a compound data structure that integrates the pose dataset and the at least one object dataset; and
inputting (S180) the compound data structure as into a trained machine learning model for classification and/or regression.

2. The method according to claim 1, further comprising:
applying (S120) human pose estimation to a plurality of frames of at least one video stream to generate human pose data stream, and extracting the pose dataset from the human pose data stream, wherein the pose dataset comprises a metadata segment and a plurality of data segments;
applying (S150) domain-specific object detection to the plurality of frames to generate at least one object dataset, wherein the pose dataset comprises a metadata segment and a plurality of data segments;
wherein the method further comprising:
outputting, by the trained machine learning model for classification and/or regression, a classification result indicating whether the captured series of human actions comply with a set of specified procedural standards.

3. The method according to claim 1, wherein the pose dataset comprises:
for each extracted frame, 2D/3D coordinates of the selected human body's keypoints, and a confidence level for each keypoint of the human body, wherein the confidence level is between 0.0 and 1.0.

4. The method according to claim 3, further comprises, adding a bounding box for each of the at least one reference object, and wherein for each extracted frame, the object dataset comprises:
2D/3D coordinates of the keypoints of the bounding box, and a confidence level for each keypoint of the reference objects.

5. The method according to claim 4, wherein generating the compound data structure comprises:
for each extracted frame, combining the determined 2D/3D coordinates of the selected human body's keypoints and the determined 2D/3D coordinates of the keypoints for each of the identified one or more reference objects, according to the metadata segment.

6. The method according to claim 4, further comprises:
applying a trainable mapping to the compound data structure to generate a fused data structure, wherein weights of the mapping are learned during a training phase;
wherein the length of the fused data structure is smaller than the sum of the lengths of the pose dataset and the object datasets.

7. The method according to claim 1, wherein the at least one video streams are captured from one or more cameras located around a scene at predetermined intervals.

8. The method according to claim 6, further comprising,
labeling, by domain expert(s) or through Quality Assurance result, for the compound data structure or the fused data structure,
training the machine learning model to obtain the trained machine learning model for classification and/or regression.

9. A method of implementing quality prediction or compliance prediction by a system comprising a processor and a non-transitory computer-readable storage medium storing instructions that, when executed, cause the system to perform the method, comprising:
receiving (S710) N compound data structures each generated according to the method of claim 1, wherein compound data structures 1 to N are each associated with a sequence of human actions which should comply with a set of specified procedural standards, and each of the sequences of human actions 1 to N is associated with an assembly portion of a final product;
adding (S720) a timestamp from a global clock for each compound data structure, wherein each of the compound data structures includes timestamp information for each extracted frame;
concatenating (S730) the N compound data structures according to their timestamp information to form a temporal sequence of data structures.

10. The method according to claim 9, further comprises:
providing (S740) the temporal sequence of data structures as input to a trained machine learning model for quality prediction; and
outputting (S750), by the trained machine learning model for quality prediction, a classification result that predicts the quality of the final product.

11. The method according to claim 9, further comprises:
receiving (S820) a result of QA for the quality of the final product,
if the result of conventional QA indicates that the quality of the final product is failure,
providing (S830) the result of QA for the quality of the final product and the temporal sequence of data structures as input to a trained machine learning model for compliance prediction;
outputting (S840), by the trained machine learning model for compliance prediction, identification which assembly portion(s) of the final product that deviated from the specified procedural standards.

12. The method according to claim 11, further comprising training the machine learning model for compliance prediction, comprising:
performing (S910), by an engineer, a post-assembly analysis when a quality assurance (QA) result for a final product result is failure;
identifying (S920) one or more assembly portions potentially contributing to the failure;
determining (S930), for each identified assembly portions, a probability of error contribution;
generating (S940) a set of labeled training data based on the determined probabilities; and
training (S950) the machine learning model for compliance prediction using the generated set of labeled training data to predict potential assembly errors and their probabilities.

13. The method of claim 12, wherein the probability of error contribution is represented as a value ranging from 0.0 to 1.0.

14. A non-transitory computer-readable storage medium having stored therein instructions which, when executed by one or more processors of a processing system, causes the processing system to perform the method according to claim 1.
